(19) United States
(12) Patent Application Publication
(10) Pub. No.: US 2011/0179057 A1
(43) Pub. Date: Jul. 21, 2011

(54) DATABASE ENGINE THROTTLING

(75) Inventor: Justyna W. Wojcik, Redmond, WA (US)

(73) Assignee: Microsoft Corporation, Redmond, WA (US)

(21) Appl. No.: 12/688,920

(22) Filed: Jan. 18, 2010

(51) Int. Cl. G06F 17/30

(52) U.S. Cl. 707/769; 718/105; 707/E17.005

(57) ABSTRACT

Architecture that includes a service which ensures that a server database engine handles different types of workload in an optimized manner. The handling includes penalizing (e.g., delaying or rejecting) query requests from a network which would otherwise bring the database engine outside of the limits for which the engine can reliably and consistently handle workloads, and for which the engine is certified. The service provides engine throttling that adapts dynamically to the workload based on the workload type and resource consumption limits. The service can also exclude system critical workloads from throttling and selectively penalize requests based on the request source to provide optimized division of resources between the workloads. The level of throttling can be adjusted according to feedback received from previously-applied actions. The architecture also includes a configuration component external to the engine for the configuration of resource consumption limits and other parameters.

### BACKGROUND

Traditional databases operating inside of a company network typically only have to deal with one type of workload, or a very restricted set of distinct workloads. A database node should be capable of handling many distinct workloads. However, node resources may be limited, or the workload may be excessive. Moreover, some workloads are more critical than the other workloads. Such critical workloads can be related to watchdogs, fabric, checkpoints, partitions, and hardware failures. For example, if queries are starved node restart may be triggered. If a machine processor is starved it may not be able to keep up with leases. Delayed checkpoints result in long database startup time. The backup process may not complete because the process constantly runs out of log space or the database is too big to fit on storage system. Additionally, partitions can exceed a certified size. If machine/cluster collapses users will not be able to execute queries anyways.

### SUMMARY

The following presents a simplified summary in order to provide a basic understanding of some novel embodiments described herein. This summary is not an extensive overview, and it is not intended to identify key/critical elements or to delineate the scope thereof. Its sole purpose is to present some concepts in a simplified form as a prelude to the more detailed description that is presented later.

The disclosed architecture includes a service which ensures that a server database engine (e.g., relational) handles different types of workload in an efficient manner. This handling includes penalizing (e.g., rejecting, delaying, etc.) query request processing from a network (e.g., the Internet) which would bring the database engine outside of the limits the engine can reliably and consistently handle workloads, and for which the engine is certified.

The service provides engine throttling (increase or decrease in workload processing for a given server node) that adapts dynamically to the workload based on the workload type and resource consumption limits. More specifically, the service can select or cause to be selected requests to penalize based on the type (e.g., read, write, etc.) of the workload (e.g., read queries, data modification, data definition, etc.), and on current resource consumption (e.g., processor, input/output, database resources, etc.).

The service can also exclude system critical workloads from throttling by defining load groups where a load group includes a set of system critical processes. Requests can be selectively penalized based on the source from which the request was received to provide fair (optimized) division of resources between the workloads. Moreover, the level of throttling can be adjusted according to feedback received from previously-applied actions (a closed loop system). The architecture also includes a configuration component external to the engine for the configuration of resource consumption limits.

To the accomplishment of the foregoing and related ends, certain illustrative aspects are described herein in connection with the following description and the annexed drawings. These aspects are indicative of the various ways in which the principles disclosed herein can be practiced and all aspects and equivalents thereof are intended to be within the scope of the claimed subject matter. Other advantages and novel features will become apparent from the following detailed description when considered in conjunction with the drawings.

### BRIEF DESCRIPTION OF THE DRAWINGS

FIG. 1 illustrates a computer-implemented database management system having a physical media, in accordance with the disclosed architecture.

FIG. 2 illustrates an alternative embodiment of a computer-implemented database management system having a configuration component.

FIG. 3 illustrates system and engine properties that can be monitored by the throttling service as part of the performance data.

FIG. 4 illustrates a database management system where the database engine employs one or more partitions to which requests are being processed.

FIG. 5 illustrates a system where the throttling service and configuration component can be utilized to manage multiple host systems.

FIG. 6 illustrates a computer implemented database management method in accordance with the disclosed architecture.

FIG. 7 illustrates additional aspects of the method of FIG. 6.

FIG. 8 illustrates a block diagram of a computing system that executes database throttling in accordance with the disclosed architecture.

FIG. 9 illustrates a schematic block diagram of a computing environment where database engine throttling can be employed.

### DETAILED DESCRIPTION

The disclosed architecture includes a service and other components which ensure that a server database engine (and engine host system) handles different types of workload in an optimized manner. The handling includes penalizing (e.g., rejecting, delaying, delaying and then rejecting, etc.) query requests from a network (e.g., the Internet) which would bring the database engine outside of the limits the engine can reliably and consistently handle workloads. A configuration component is provided for the configuration of resource consumption limits and other parameters.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives falling within the spirit and scope of the claimed subject matter.

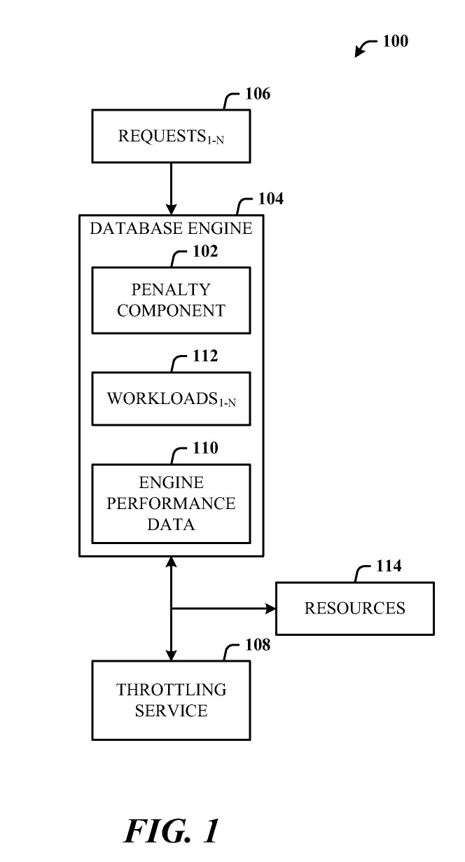

FIG. 1 illustrates a computer-implemented database management system 100 having a physical media, in accordance with the disclosed architecture. The system 100 includes a penalty component 102 of a database engine 104 controlled to selectively penalize (e.g., reject, or delay by enquing) one or more incoming query requests 106 to impact processing of the one or more requests. The system 100 can also include a throttling service 108 that monitors engine performance data 110 associated with the database engine 104 and adjusts workloads 112 via the penalty component 102 to maintain engine performance within consumption limits of available resources 114.

The service 108 determines when to throttle, how much to throttle, what type of load should be throttled, and what load should be throttle first, for example. The “when” aspect can be determined according to limits (e.g., soft and hard) where a hard limit results in the workload being stopped or the request being rejected. The soft limit can be used in a closed loop technique based on the current state and rate of change (slope) of the error. More specifically, the soft limit checks the current state, which can be ascertained based on the maximum error of an individual counter and the average error over all counters. A percentage of the load that should be throttled can then be computed.

The throttling service 108 automatically (e.g., dynamically) adjusts handling of the workloads 112 by controlling the penalty component 102 to reject one or more of the query requests 106 in response to changes in the monitored performance data 110. The throttling service 108 can automatically (e.g., dynamically) adjust handling of the workloads 112 by controlling the penalty component 102 to delay processing of one or more of the query requests 106 in response to changes in the monitored performance data 110. A request can be penalized based on request type and on resource consumption for the request type. The throttling service 108 can further monitor performance data associated with a host system (not shown) of the database engine 104 and adjusts handling of the workloads 112 via the penalty component 102 based on one or more of the performance data of the host system and database engine 104 to maintain database engine performance within limits of resource consumption.

The throttling service 108 can be configured to ignore adjustment of workloads 112 that relate to system critical processes or other processes deemed to be suitable for avoiding adjustment. The workloads 112 can be categorized into load groups, where such as a load group defined to include the system critical processes is ignored from throttling. The throttling service 108 rejects or delays a request based on a source of the request to optimize resource consumption among the workloads 112 and across engine partitions (not shown) of the engine 104. The service 108 can also compute a trend of resource consumption of an engine partition relative to the limits and throttle back on a workload associated with the partition for which the trend indicates resource consumption will exceed the limits.

The following are examples for which penalization can be made. With respect to upsert (update and insert) request types, an insert request and update request can be rejected or delayed based on the database space used and partition size. With respect to writes, update, insert and delete requests can be rejected or delayed based on the log write delay and log space used. All requests can be rejected or delayed based on a delay in data reads, busy workers, and CPU utilization.

Note that the system 100 can be one of many systems in a computing cluster, for example, each configured similarly to handle requests from a network (e.g., Internet) for processing as workloads against one or more database partitions (replicas). Alternatively, the system 100 can be one of many systems in a computing cloud, for example, each configured similarly to handle requests in the same manner.

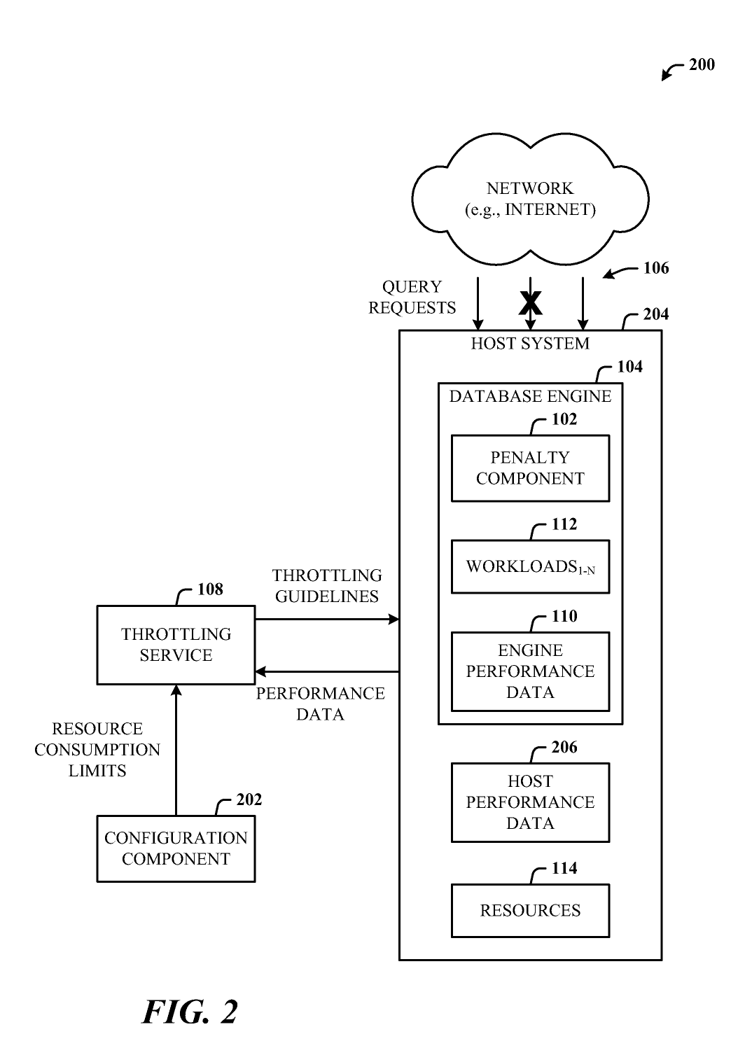

FIG. 2 illustrates an alternative embodiment of a computer-implemented database management system 200 having a configuration component 202. The configuration component 202 can be employed for configuring the resource consumption limits. Additionally, the configuration component 202 can be implemented external to the database engine 104. The engine 104 is shown as being hosted on a host system 204 (e.g., server).

As illustrated, the system 200 includes the penalty component 102 as part of the database engine 104 controlled by the throttling service 108 to selectively reject (designated by the bolded “X”) and/or delay one or more of the incoming query requests 106. The throttling service 108 monitors the engine performance data 110 and controls the penalty component 102 to adjust the workloads 112 to maintain engine performance within consumption limits of available resources 114.

Alternatively, or in combination therewith, the throttling service 108 can monitor host performance data 206 associated with the host system 204 and adjusts handling of the workloads 112 based on one or more of the performance data (110 and 206) of the database engine 104 and host system 204 to maintain database engine performance within limits of resource consumption.

As further illustrated, the configuration component 202 interfaces to the throttling service 108 to pass resource consumption limit information thereto, for example. Other information can be passed to the service 108 as well, as desired.

The throttling service 108 then sends throttling guidelines to the host system 204 where the engine workloads 112 are managed accordingly in order to maintain optimum resources handling for this host system 204. The host system 204 can then send back performance data (engine performance data and/or host performance data) to the service 108 for processing. For example, the service 108 can automatically (e.g., dynamically) compute trends for each workload to determine if the workload is consuming more resources than desired, as defined by the limits. The throttling service 108 can then automatically (e.g., dynamically) adjust handling of the workloads 112 by rejecting one or more of the query requests 106 in response to changes in the monitored performance data.

The guidelines, as received at the host from the service 108, can include reasons for throttling and a severity measure. The guidelines can be set on a per partition basis. The engine 104 can filter the load accordingly. When using a primary partition and secondary partitions, the engine filtering can be configured for traffic on the primary only, for example.

Secondary partition throttling can be accommodated as well. This enforces log and database space limits without control of the secondary traffic, but as a “best effort” basis only. For the secondary partitions, performance data can include monitoring only a limited set of “persistent” counters (e.g., log, dbspace, etc.), and then act only when loading is considered to be onerous. Additionally, the guidelines can be applied to the secondary machine (having the secondary partition) and then take action on the primary machine hosting the primary partition.

Similarly, the service 108 can automatically (e.g., dynamically) compute trends for each workload to determine if the workload is consuming fewer resources than desired, and as defined by the limits. The throttling service 108 can then adjust handling of the workloads 112 by allowing more of the query requests 106 to be processed by the host system 204 (and engine 104) in response to changes in the monitored performance data (110 and/or 206).

As described previously, the throttling service 108 can be configured to ignore the adjustment of workloads 112 that relate to system critical processes. Moreover, the workloads 112 can be categorized into load groups, such as a critical load group defined to include only the system critical processes.

Put another way, there is provided a computer-implemented database management system 200 having a physical storage media, the system 200 comprising the penalty component 102 of the database engine 104 controlled to selectively penalize one or more incoming query requests 106, the throttling service 108 that monitors performance data 110 associated with the database engine 104 and performance data 206 with the host system 204. The service 108 controls the penalty component 102 to adjust workloads 112 to maintain engine performance within consumption limits of available resources 114. The configuration component 202 facilitates configuration of the consumption limits.

The throttling service 108 dynamically adjusts handling of the workloads 112 by rejecting or delaying a request (of the request 106) in response to changes in the monitored performance data (110 and/or 206). The request can be rejected or delayed based on request type and/or on resource consumption for the request type. The throttling service 108 ignores the adjustment of workloads 112 that relate to system critical processes based on defined load groups. The configuration component 202 can further facilitate automatic adjustment of throttling of the throttling service 108 according to feedback based on previously-applied actions.

The systems 100 and 200, for example, can be backend (or middle tier) server systems that employ the disclosed throttling and penalty mechanism. As shown and described herein, the throttling architecture is built of two cooperating parts: the mechanism for penalizing queries (the penalty component 102) built into the engine 104 (e.g., SQL server engine) and the service 108 that configures the mechanism based on the observed performance data. The service 108 knows the state of all monitored performance counters of the server, knows what mitigating actions have been taken, and adjusts the actions based on the feedback.

Note that the system 200 can be one of many systems in a computing cluster, for example, each configured similarly to handle requests from a network (e.g., Internet) for processing as workloads against one or more database partitions (replicas). Alternatively, the system 200 can be one of many systems in a computing cloud, for example, each configured similarly to handle requests in the same manner.

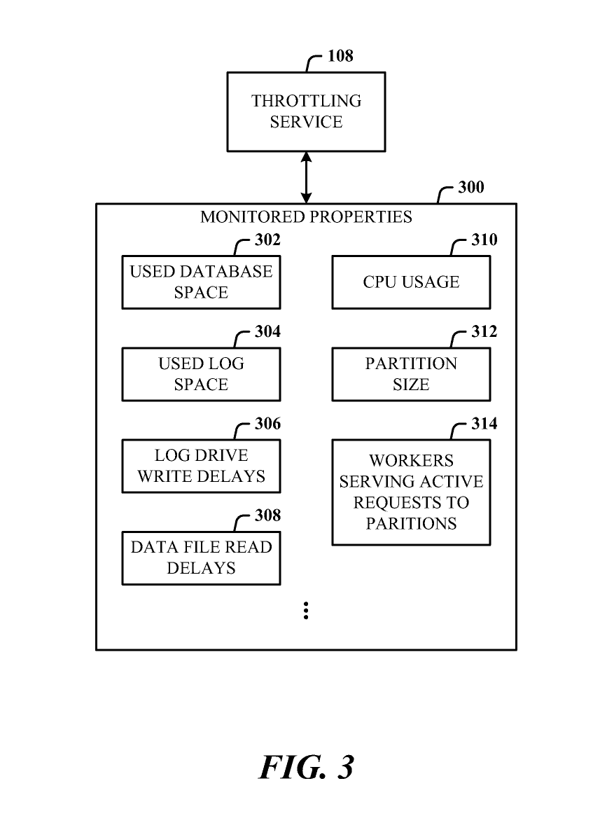

FIG. 3 illustrates system and engine properties 300 that can be monitored by the throttling service 108 as part of the performance data. The monitored properties 300 include, but are not limited to, used database space 302 (e.g., percentage of), used log space 304 (e.g., percentage of), log drive write delays 306, data file read delays 308, CPU usage 310, individual partition size 312, and the number of workers (threads or processes) 314 serving active requests to the partitions.

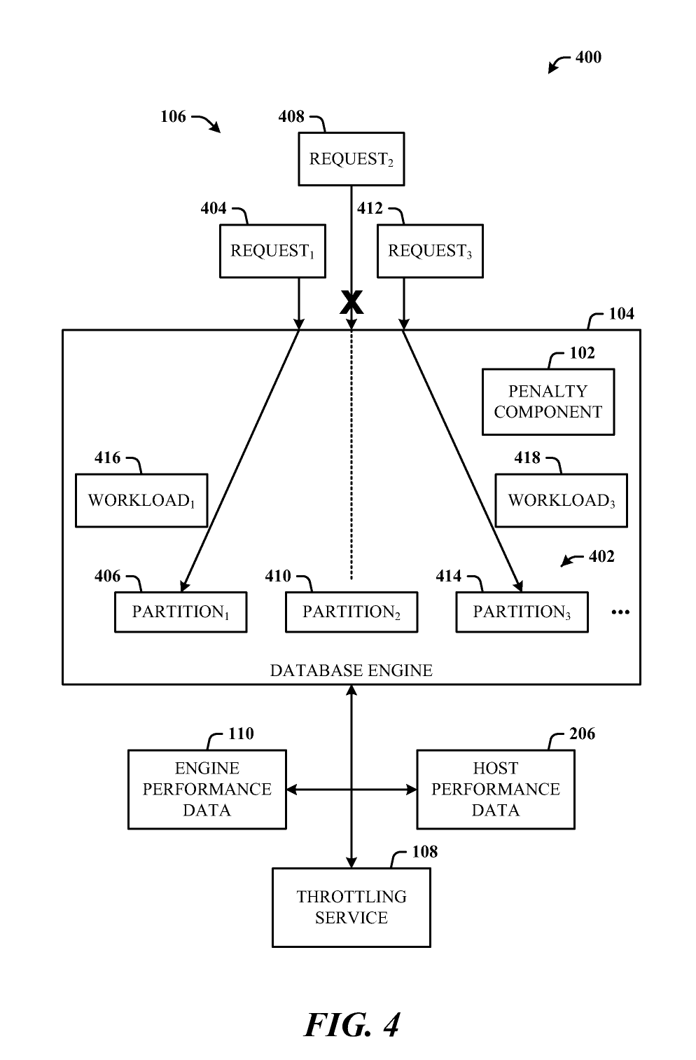

FIG. 4 illustrates a database management system 400 where the database engine employs one or more partitions 402 to which requests 106 are being processed. For example, a first request 404 is processed to be directed to a first partition 406 of the database engine 104, a second request 408 for normal processing to a second partition 410 is rejected for various reasons as described herein, and a third request 412 is processed to be directed to a third partition 414. The processing of the first request 404 is associated with a first workload 416 and the processing of the third request 412 is associated with a third workload 418. The throttling service 108 obtains the engine performance data 110 and/or host performance data 206 and adjusts the workloads (requests) accordingly.

Note that in many instances only one partition will be hosted. However, it is possible to host multiple partitions as illustrated. Moreover, the partitions 402 can include a primary partition and multiple secondary (or backup) partitions.

The throttling service 108 can monitor system (or host) performance and partition (engine) performance. For example, depending on system performance, partition usage statistics, and previously taken throttling actions, the service 108 sets the appropriate throttling state on each of the partitions 402.

Separating the monitoring and configuration functionality external to the engine 104 provides a flexible scheme that does not require engine reloads and adds the flexibility to run on the backend machine or elsewhere.

The throttling service 108 can sort the partitions 402 based on partition load factor and can then start the throttling based on the partitions that are the busiest. This approach penalizes the source of the excessive traffic (e.g., request 408). The top n requests can be selected that amount to the desired percentage of load to throttle. Alternatively, workload can be adjusted based on a rotation of request to the partitions, for example. Other suitable adjustments can be employed as desired.

The service 108 can use feedback from the host system to adjust its actions. For example, the service 108 can initiate throttling based on a predetermined percentage value of total load. If the load condition persists or gets worse, the service 108 can increase this value; if the condition is mitigated, the service 108 can gradually decrease the value.

Throttling actions will be also taken based on exceeding soft and/or hard limits, where the soft limit can be bypassed by more applications. If a soft limit is exceeded for too long, the soft limit can be adjusted to become a hard limit. For the hard limit, once exceeded, the services throttle most of the associated host clients. For example, a soft limit can be set to fifty percent of the resources and the hard limit set to seventy-five percent of the resources. The service can allow an engine workload to operate between the soft limit and the hard limit for a limited period of time or for an extended period of time, as desired. As previously described with respect to trending, should the ramp-up (or slope) of the workload as computed crossing the soft limit indicate, as extrapolated out over time, that the workload will exceed (or equal) the hard limit, the service can then throttle back the workload to prevent over consumption of the resource.

Throttling guidelines can be set for each partition. Based on the current throttling guidelines set for each partition by the configuration component the database engine can determine (compute) whether to serve or reject an incoming request. The type of the request (e.g., select, insert, update, etc.) is also considered such that the requests that do not consume the resources that are currently in high demand, can still be allowed through for processing.

As previously indicated, the criteria employed to determine if the query request is to be rejected by the engine, can be made a product of the following: throttling guidelines set by the service on the partition metadata, type of the incoming request (e.g., insert, update, select), and source of the query. Knowing the query owner can provide information about the query importance (e.g., system critical query versus common user load). The guidelines indicate that the types of query that can be throttled include, but are not limited to: all requests, inserts, updates, any query that produces write I/O, etc. The guidelines also include the resource that is the reason for throttling (e.g., low disk space, CPU overload, etc.) together with severity of the condition (e.g., soft or hard limit exceeded). Distinguishing between different workloads is one of the main benefits of throttling and allows higher priority given to system critical queries.

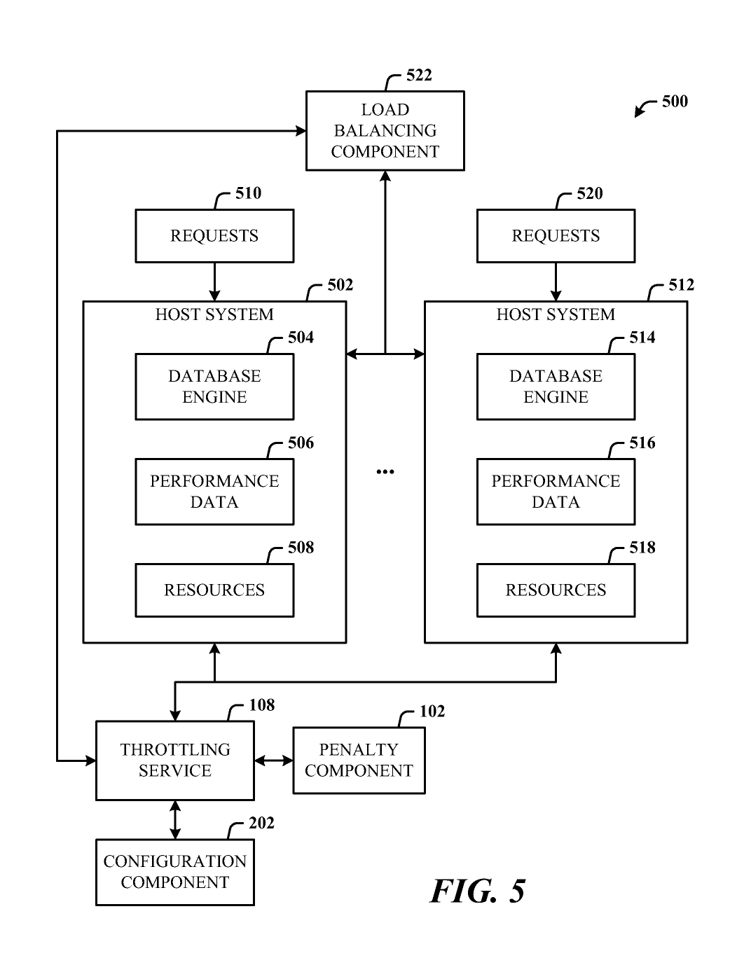

FIG. 5 illustrates a system 500 where the throttling service 108 and configuration component 202 can be utilized to manage multiple host systems. A first host system 502 includes a first database engine 504 (e.g., engine 104), performance data 506 for the host system 502 and/or engine 504 (e.g., engine performance data 110 and host performance data 206), and resources 508 (e.g., hardware and/or software). Requests 510 can be received at the first host system 502 for processing against one or more engine partitions (not shown). A second host system 512 includes a second database engine 514 (e.g., engine 104), performance data 516 for the host system 512 and/or engine 514, and resources 518 (e.g., hardware and/or software). Requests 520 can be received at the first host system 502 for processing against one or more engine partitions (not shown).

Here, the throttling service 108 and the configuration component 202 are configured to interact and manage both of the host systems (502 and 512). In cooperation with the rejection components (not shown) of each engine (504 and 514), the throttling service 108 can receive and process the respective performance data, and adjust workloads by rejecting requests for each of the host systems (502 and 512).

In an alternative implementation, the throttling service 108 can communicate with a load balancing component 522 that routes the requests to the proper host systems (and partitions). Where each host system includes backup replicas of other systems, the throttling service can direct that the load balancing component 522 reroute requests according to workload of a specific host system (database engine).

Note that the host systems (502 and 512) can be some of the many systems in a computing cluster, for example, each configured similarly to handle requests from a network (e.g., Internet) for processing as workloads against one or more database partitions (replicas). Alternatively, the host systems (502 and 512) can be some of the many systems in a computing cloud, for example, each configured similarly to handle requests in the same manner.

Note that a goal can be to also provide fairness between multiple customers (e.g., partitions) over the same set of resources of a single machine (or perhaps other physical and/or virtual machines) to assure that each customer receives a fair portion of the resources. For example, it is desired to ensure that a partition that receives a high number of requests at a time does not starve or delay a single request directed to another partition. This fairness can include interleaving the resources between the different customer requests, for example, apportioning the resources based on the number of requests, apportioning the resources based on the type of requests, apportioning the resources based on the importance of a request, apportioning the resources based on the look-ahead approximation and extent of resources that might be required to process the request(s), etc.

Included herein is a set of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

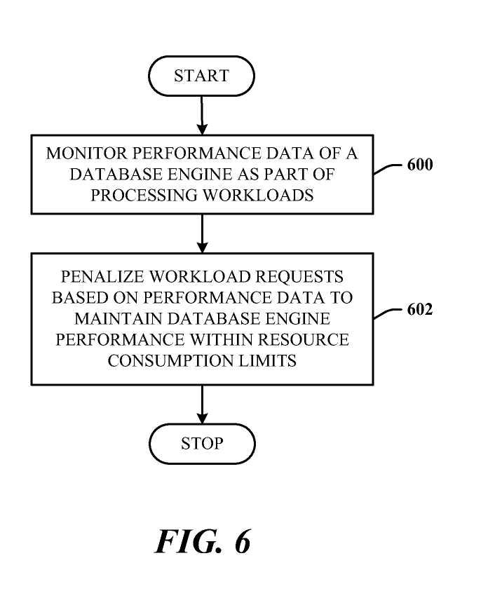

FIG. 6 illustrates a computer implemented database management method in accordance with the disclosed architecture. At 600, performance data of a database engine is monitored as part of processing workloads. At 602, workload requests are penalized based on the performance data to maintain database engine performance within resource consumption limits.

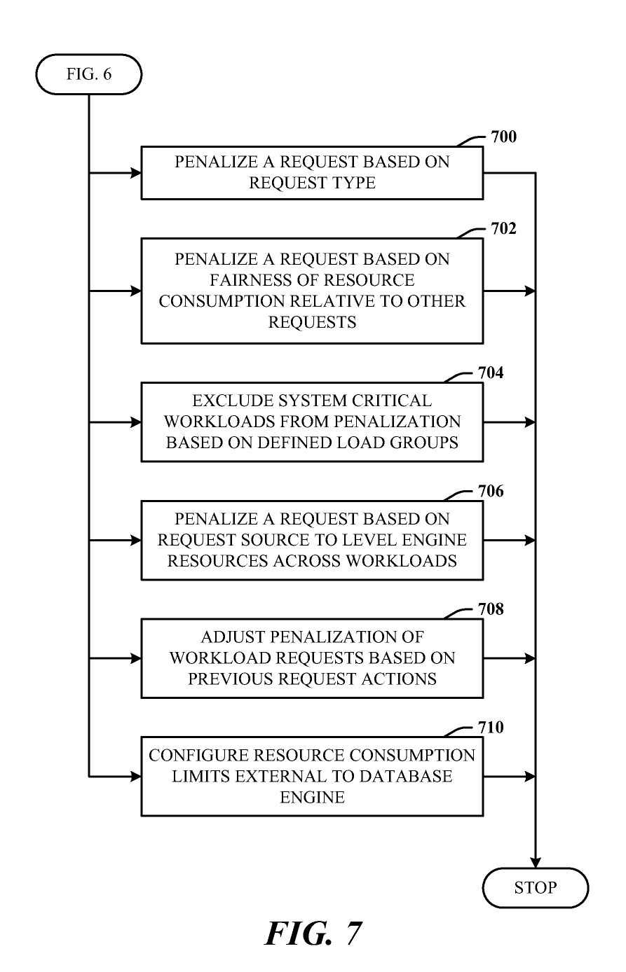

FIG. 7 illustrates additional aspects of the method of FIG. 6. At 700, a request is penalized by rejecting or delaying the request based on request type. At 702, a request is penalized based on fairness of resource consumption relative to other requests. At 704, system critical workloads are excluded from penalization based on defined load groups. At 706, a request is penalized based on request source to level engine resources across workloads. At 708, penalization of the workload requests is adjusted based on previous request actions. At 710, the resource consumption limits are configured external to the database engine.

As used in this application, the terms “component” and “system” are intended to refer to a computer-related entity, either hardware, a combination of software and tangible hardware, software, or software in execution. For example, a component can be, but is not limited to, tangible components such as a processor, chip memory, mass storage devices (e.g., optical drives, solid state drives, and/or magnetic storage media drives), and computers, and software components such as a process running on a processor, an object, an executable, module, a thread of execution, and/or a program. By way of illustration, both an application running on a server and the server can be a component. One or more components can reside within a process and/or thread of execution, and a component can be localized on one computer and/or distributed between two or more computers. The word “exemplary” may be used herein to mean serving as an example, instance, or illustration. Any aspect or design described herein as “exemplary” is not necessarily to be construed as preferred or advantageous over other aspects or designs.

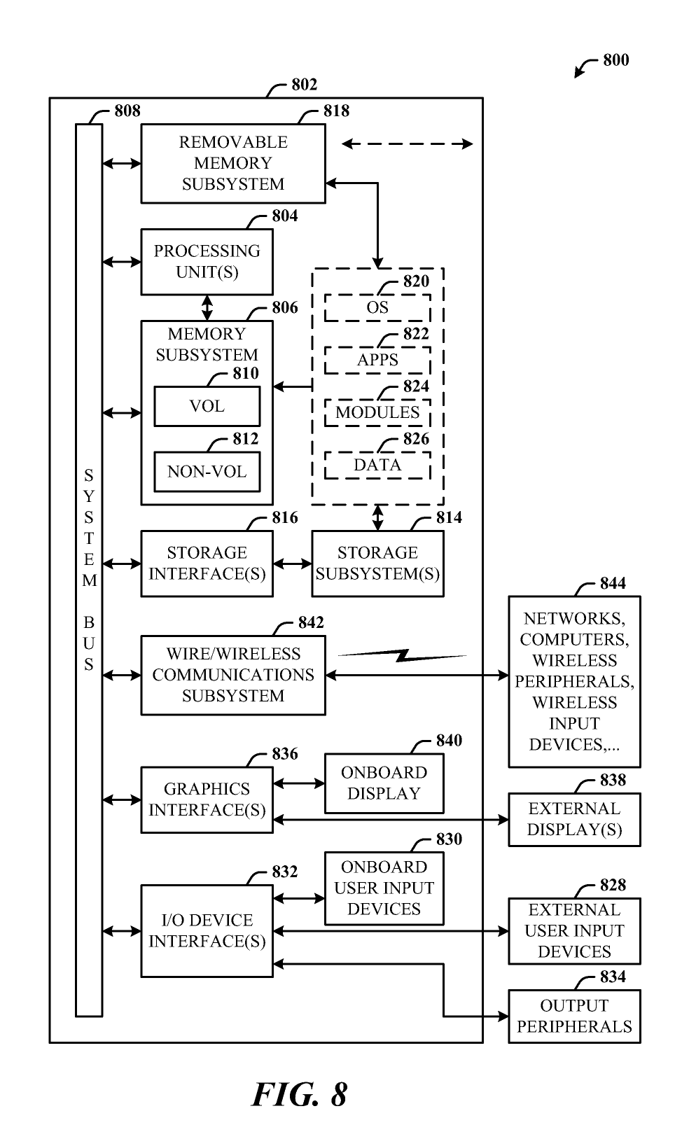

Referring now to FIG. 8, there is illustrated a block diagram of a computing system 800 that executes database throttling in accordance with the disclosed architecture. In order to provide additional context for various aspects thereof, FIG. 8 and the following description are intended to provide a brief, general description of the suitable computing system 800 in which the various aspects can be implemented. While the description above is in the general context of computer-executable instructions that can run on one or more computers, those skilled in the art will recognize that a novel embodiment also can be implemented in combination with other program modules and/or as a combination of hardware and software.

The computing system 800 for implementing various aspects includes the computer 802 having processing unit(s) 804, a computer-readable storage such as a system memory 806, and a system bus 808. The processing unit(s) 804 can be any of various commercially available processors such as single-processor, multi-processor, single-core units and multi-core units. Moreover, those skilled in the art will appreciate that the novel methods can be practiced with other computer system configurations, including minicomputers, mainframe computers, as well as personal computers (e.g., desktop, laptop, etc.), hand-held computing devices, microprocessor-based or programmable consumer electronics, and the like, each of which can be operatively coupled to one or more associated devices.

The system memory 806 can include computer-readable storage (physical storage media) such as a volatile (VOL) memory 810 (e.g., random access memory (RAM)) and non-volatile memory (NON-VOL) 812 (e.g., ROM, EPROM, EEPROM, etc.). A basic input/output system (BIOS) can be stored in the non-volatile memory 812, and includes the basic routines that facilitate the communication of data and signals between components within the computer 802, such as during startup. The volatile memory 810 can also include a high-speed RAM such as static RAM for caching data.

The system bus 808 provides an interface for system components including, but not limited to, the system memory 806 to the processing unit(s) 804. The system bus 808 can be any of several types of bus structure that can further interconnect to a memory bus (with or without a memory controller), and a peripheral bus (e.g., PCI, PCIe, AGP, LPC, etc.), using any of a variety of commercially available bus architectures.

The computer 802 further includes machine readable storage subsystem(s) 814 and storage interface(s) 816 for interfacing the storage subsystem(s) 814 to the system bus 808 and other desired computer components. The storage subsystem(s) 814 (physical storage media) can include one or more of a hard disk drive (HDD), a magnetic floppy disk drive (FDD), and/or optical disk storage drive (e.g., a CD-ROM drive DVD drive), for example. The storage interface(s) 816 can include interface technologies such as EIDE, ATA, SATA, and IEEE 1394, for example.

One or more programs and data can be stored in the memory subsystem 806, a machine readable and removable memory subsystem 818 (e.g., flash drive form factor technology), and/or the storage subsystem(s) 814 (e.g., optical, magnetic, solid state), including an operating system 820, one or more application programs 822, other program modules 824, and program data 826.

As a server machine, the one or more application programs 822, other program modules 824, and program data 826 of the computer system 802 can include the components and entities of the system 100 of FIG. 1, the host system 204 and its components and entities and the service 108 and configuration component 202 of FIG. 2, the monitored properties 300 of FIG. 3, the partitions 402 (primary and/or secondary) and components/entities of the system 400 of FIG. 4, be a host system (e.g., host system 502 of FIG. 5), and the methods represented by the flow charts of FIGS. 6-7, for example.

Generally, programs include routines, methods, data structures, other software components, etc., that perform particular tasks or implement particular abstract data types. All or portions of the operating system 820, applications 822, modules 824, and/or data 826 can also be cached in memory such as the volatile memory 810, for example. It is to be appreciated that the disclosed architecture can be implemented with various commercially available operating systems or combinations of operating systems (e.g., as virtual machines).

The storage subsystem(s) 814 and memory subsystems (806 and 818) serve as computer readable media for volatile and non-volatile storage of data, data structures, computer-executable instructions, and so forth. Computer readable media can be any available media that can be accessed by the computer 802 and includes volatile and non-volatile internal and/or external media that is removable or non-removable. For the computer 802, the media accommodate the storage of data in any suitable digital format. It should be appreciated by those skilled in the art that other types of computer readable media can be employed such as zip drives, magnetic tape, flash memory cards, flash drives, cartridges, and the like, for storing computer executable instructions for performing the novel methods of the disclosed architecture.

A user can interact with the computer 802, programs, and data using external user input devices 828 such as a keyboard and a mouse. Other external user input devices 828 can include a microphone, an IR (infrared) remote control, a joystick, a game pad, camera recognition systems, a stylus pen, touch screen, gesture systems (e.g., eye movement, head movement, etc.), and/or the like. The user can interact with the computer 802, programs, and data using onboard user input devices 830 such a touchpad, microphone, keyboard, etc., where the computer 802 is a portable computer, for example. These and other input devices are connected to the processing unit(s) 804 through input/output (I/O) device interface(s) 832 via the system bus 808, but can be connected by other interfaces such as a parallel port, IEEE 1394 serial port, a game port, a USB port, an IR interface, etc. The I/O device interface(s) 832 also facilitate the use of output peripherals 834 such as printers, audio devices, camera devices, and so on, such as a sound card and/or onboard audio processing capability.

One or more graphics interface(s) 836 (also commonly referred to as a graphics processing unit (GPU)) provide graphics and video signals between the computer 802 and external display(s) 838 (e.g., LCD, plasma) and/or onboard displays 840 (e.g., for portable computer). The graphics interface(s) 836 can also be manufactured as part of the computer system board.

The computer 802 can operate in a networked environment (e.g., IP-based) using logical connections via a wired/wireless communications subsystem 842 to one or more networks and/or other computers. The other computers can include workstations, servers, routers, personal computers, microprocessor-based entertainment appliances, peer devices or other common network nodes, and typically include many or all of the elements described relative to the computer 802. The logical connections can include wired/wireless connectivity to a local area network (LAN), a wide area network (WAN), hotspot, and so on. LAN and WAN networking environments are commonplace in offices and companies and facilitate enterprise-wide computer networks, such as intranets, all of which may connect to a global communications network such as the Internet.

When used in a networking environment the computer 802 connects to the network via a wired/wireless communication subsystem 842 (e.g., a network interface adapter, onboard transceiver subsystem, etc.) to communicate with wired/wireless networks, wired/wireless printers, wired/wireless input devices 844, and so on. The computer 802 can include a modem or other means for establishing communications over the network. In a networked environment, programs and data relative to the computer 802 can be stored in the remote memory/storage device, as is associated with a distributed system. It will be appreciated that the network connections shown are exemplary and other means of establishing a communications link between the computers can be used.

The computer 802 is operable to communicate with wired/wireless devices or entities using the radio technologies such as the IEEE 802.xx family of standards, such as wireless devices operatively disposed in wireless communication (e.g., IEEE 802.11 over-the-air modulation techniques) with, for example, a printer, scanner, desktop and/or portable computer, personal digital assistant (PDA), communications satellite, any piece of equipment or location associated with a wirelessly detectable tag (e.g., a kiosk, news stand, restroom), and telephone. This includes at least Wi-Fi (or Wireless Fidelity) for hotspots, WiMax, and Bluetooth™ wireless technologies. Thus, the communications can be a predefined structure as with a conventional network or simply an ad hoc communication between at least two devices. Wi-Fi networks use radio technologies called IEEE 802.11x (a, b, g, etc.) to provide secure, reliable, fast wireless connectivity. A Wi-Fi network can be used to connect computers to each other, to the Internet, and to wire networks (which use IEEE 802.3-related media and functions).

The illustrated aspects can be practiced in distributed computing environments where certain tasks are performed by remote processing devices that are linked through a communications network. In a distributed computing environment, program modules can be located in local and/or remote storage and/or memory system.

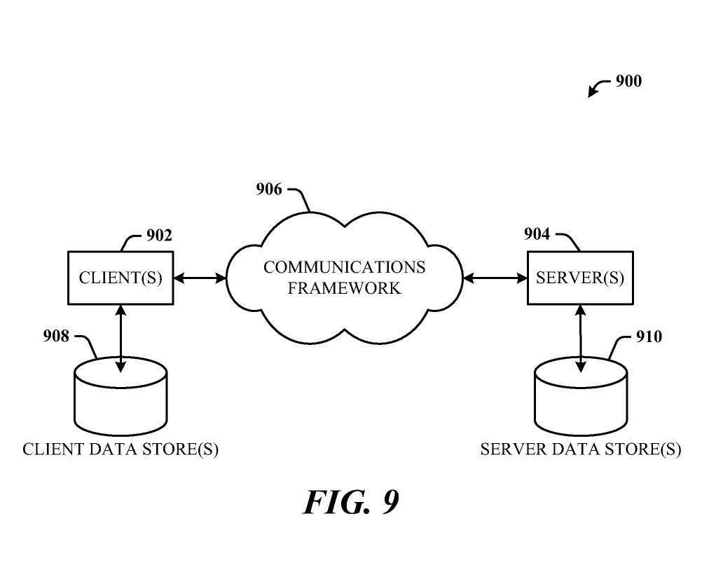

Referring now to FIG. 9, there is illustrated a schematic block diagram of a computing environment 900 where database engine throttling can be employed. The environment 900 includes one or more client(s) 902. The client(s) 902 can be hardware and/or software (e.g., threads, processes, computing devices). The client(s) 902 can house cookie(s) and/or associated contextual information, for example.

The environment 900 also includes one or more server(s) 904. The server(s) 904 can also be hardware and/or software (e.g., threads, processes, computing devices). The servers 904 can house threads to perform transformations by employing the architecture, for example. One possible communication between a client 902 and a server 904 can be in the form of a data packet adapted to be transmitted between two or more computer processes. The data packet may include a cookie and/or associated contextual information, for example. The environment 900 includes a communication framework 906 (e.g., a global communication network such as the Internet) that can be employed to facilitate communications between the client(s) 902 and the server(s) 904.

Communications can be facilitated via a wire (including optical fiber) and/or wireless technology. The client(s) 902 are operatively connected to one or more client data store(s) 908 that can be employed to store information local to the client(s) 902 (e.g., cookie(s) and/or associated contextual information). Similarly, the server(s) 904 are operatively connected to one or more server data store(s) 910 that can be employed to store information local to the servers 904.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A computer-implemented database management system having a physical storage media, comprising:
a penalty component of a database engine controlled to selectively penalize one or more incoming query requests to impact processing of the one or more requests; and
a throttling service that monitors performance data associated with the database engine and adjusts workloads via the penalty component to maintain engine performance within consumption limits of available resources.

2. The system of claim 1, wherein the throttling service dynamically adjusts handling of the workloads by controlling the penalty component to reject one or more of the query requests in response to changes in the monitored performance data.

3. The system of claim 2, wherein a request is rejected based on request type and on resource consumption for the request type.

4. The system of claim 1, wherein the throttling service further monitors performance data associated with a host system of the database engine and adjusts handling of the workloads via the penalty component based on one or more of the performance data of the host system and database engine to maintain database engine performance within limits of resource consumption.

5. The system of claim 1, wherein the throttling service ignores adjustment of workloads that relate to system critical processes.

6. The system of claim 5, wherein the workloads are categorized into load groups, where a load group defined to include the system critical processes is ignored from throttling.

7. The system of claim 1, wherein the throttling service rejects a request or delays a request based on a source of the request to optimize resource consumption among the workloads and across engine partitions.

8. The system of claim 1, wherein the service computes a trend of resource consumption of an engine partition relative to the limits and throttles back on a workload associated with the partition for which the trend indicates resource consumption will exceed the limits.

9. The system of claim 1, further comprising a configuration component for configuring the limits, the configuration component implemented external to the database engine, which is a relational database engine.

10. A computer-implemented database management system having a physical storage media, comprising:
a penalty component of a database engine controlled to selectively penalize one or more incoming query requests;
a throttling service that monitors performance data associated with the database engine and with a host system, the service adjusts workloads via the penalty component to maintain engine performance within consumption limits of available resources; and
a configuration component for configuring the consumption limits.

11. The system of claim 10, wherein the throttling service dynamically adjusts handling of the workloads by rejecting or delaying a request in response to changes in the monitored performance data, the request rejected or delayed based on request type and on resource consumption for the request type.

12. The system of claim 10, wherein the throttling service ignores the adjustment of workloads that relate to system critical processes.

13. The system of claim 10, wherein the configuration component facilitates automatic adjustment of throttling of the throttling service according to feedback based on previously-applied actions.

14. A computer-implemented database management method that employs a processor and memory, comprising:
monitoring performance data of a database engine as part of processing workloads; and
penalizing workload requests based on the performance data to maintain database engine performance within resource consumption limits.

15. The method of claim 14, further comprising penalizing a request by rejecting or delaying the request based on request type.

16. The method of claim 14, further comprising penalizing a request based on fairness of resource consumption relative to other requests.

17. The method of claim 14, further comprising excluding system critical workloads from penalization based on defined load groups.

18. The method of claim 14, further comprising penalizing a request based on request source to level engine resources across workloads.

19. The method of claim 14, further comprising adjusting penalization of the workload requests based on previous request actions.

20. The method of claim 14, further comprising configuring the resource consumption limits external to the database engine.
